(19) United States
(12) Patent Application Publication
(10) Pub. No.: US 2015/0071362 A1
(43) Pub. Date: Mar. 12, 2015

(54) IMAGE ENCODING DEVICE, IMAGE DECODING DEVICE, IMAGE ENCODING METHOD, IMAGE DECODING METHOD AND PROGRAM

(71) Applicant: Sharp Kabushiki Kaisha, Osaka-shi, Osaka (JP)

(72) Inventors: Tadashi Uchiumi, Osaka-shi (JP); Yoshiya Yamamoto, Osaka-shi (JP)

(21) Appl. No.: 14/388,284

(22) PCT Filed: Mar. 25, 2013
(86) PCT No.: PCT/JP2013/058497

§ 371 Date: Sep. 26, 2014

(30) Foreign Application Priority Data
Mar. 30, 2012 (JP) 2012-081867

(51) Int. Cl. H04N 13/00; H04N 19/46

(52) U.S. Cl. CPC H04N 13/0048; H04N 19/46
USPC 375/240.26

(57) ABSTRACT

The present invention enables joint use of multiple schemes that are different in relationship of dependency between viewpoint images and depth images in encoding and decoding for encoding or decoding of viewpoint images and depth images. An image encoding device determines one of encoding scheme having different reference relationships between viewpoint images and depth images at intervals of a predetermined encoding scheme change data unit and encodes viewpoint images and depth images with the determined encoding scheme. The image encoding device inserts inter-image reference information indicating the reference relationships between the viewpoint images and depth images in encoding into an encoded data sequence. The image decoding device determines a decoding scheme and an order of decoding in accordance with the reference relationships indicated by the inter-image reference information and decodes the viewpoint images and depth images with the determined decoding scheme and in the determined order of decoding.

### TECHNICAL FIELD

The present invention relates to an image encoding device, image decoding device, image encoding method, image decoding method, and program.

### BACKGROUND ART

Recording or transmission of images taken from different viewpoints and reproduction thereof enables a user or viewer to see an image from a viewing angle of his/her choice.

As an example, multi-angle video for DVD-Video is created by preparing images taken at the same time from different viewpoints which are likely to attract viewers' interest or which the creator wants to present to users. The user can switch to and see reproduction of a particular image by performing certain operations during reproduction.

Realization of such multi-angle video functions requires all of multiple images corresponding to the individual angles (viewpoints) to be recorded. Accordingly, as the number of viewpoints increases, for example, the size of video content data becomes large. For this reason, multi-angle video is prepared in practice only for scenes which the creator especially wants to show or viewers are likely to be particularly interested in, for example, thereby creating video content within the capacity of a recording media, for example.

For videos of sports, concerts, or performing arts in particular, for example, viewpoints of interest vary from user to user. Given this fact, it is desirable to be able to provide images taken from as many viewpoints as possible to users.

In response to this demand, image encoding devices that encode both multiple viewpoint images and depth information corresponding to the viewpoint images and generate stream data containing the encoded data are known (see PTL 1 for instance).

Depth information is information representing the distance between a subject present in the viewpoint image and the observation position (the camera position). By determining the position in a three-dimensional space of a subject present in the viewpoint image by computation based on depth information and camera position information, a captured scene can be virtually reproduced. By then performing projective transformation of the reproduced scene onto a screen corresponding to a different camera position, an image that would be seen from a certain viewpoint can be generated.

Depth information is information representing the distance (i.e., depth) from the viewpoint position (camera position) at which the image was captured by an image capture device, such as a camera, to a subject in the captured image as a numerical value in a predetermined range (8 bits for example). The distance represented by such a numerical value is then converted to a pixel intensity value to obtain depth information in the form of a monochrome image. This enables the depth information to be encoded (compressed) into an image.

The image encoding device disclosed by PTL 1 employs an encoding scheme that combines predictive coding in time direction and predictive coding in viewpoint direction in compliance with multi-view video coding (MVC), a multi-view image encoding scheme, in relation to multiple input viewpoint images. The image encoding device of PTL 1 also employs predictive coding both in time and viewpoint directions for depth information to improve efficiency of encoding.

Another known video encoding method for encoding multi-view images and depth images is to generate a disparity-compensated image for a viewpoint other than the reference viewpoint based on a depth image (a distance image) and positional relationship among cameras and apply predictive coding between the generated disparity-compensated image and the actual input image (see PTL 2 for example). This video encoding method thus seeks to improve the efficiency of encoding of viewpoint images by making use of depth images. A video encoding method of this type generates a disparity-compensated image using a depth image that has been once encoded and decoded again due to the necessity of obtaining the same disparity-compensated image in encoding and decoding. Consequently, encoding and decoding of viewpoint images depend on the results of encoding and decoding of depth images.

Another known video encoding method is to utilize information such as motion vectors obtained in predictive coding of viewpoint images for encoding depth images when encoding depth images (DEPTH: defined as one of Multiple Auxiliary Components) together with viewpoint images (video) (see NPL 1 for instance). In this video encoding method, encoding and decoding of depth images are dependent on the results of encoding and decoding of viewpoint images as opposed to PTL 2.

### CITATION LIST

### Patent Literature

PTL 1: Japanese Unexamined Patent Application Publication No. 2010-157823
PTL 2: Japanese Unexamined Patent Application Publication No. 2007-36800

### Non Patent Literature

NPL 1: “Coding of audio-visual objects: Visual”, ISO/IEC 14496-2: 2001

### DISCLOSURE OF THE INVENTION

### Problems to be Solved by the Invention

As PTL 2 and NPL 1 show, encoding of viewpoint images and depth images allows video corresponding to many viewpoints to be generated with a relatively small amount of data. These encoding methods however have different relations of dependency: one of the methods makes use of depth image information for encoding of viewpoint images and the other makes use of viewpoint image information for encoding of depth images, for example. Moreover, the encoding of PTL 1 has no relationship of utilization between viewpoint images and depth images. These multi-view image encoding schemes are thus different in relationship of dependency between viewpoint images and depth images. The multi-view image encoding schemes have their own advantages.

These image encoding schemes however cannot be used concurrently because they have different relationships of dependency between viewpoint images and depth images in encoding and decoding. It is therefore a common practice to determine and consistently use a particular image encoding method for a certain type of device or service. It is then impossible to handle a situation where use of another encoding scheme is advantageous over the predetermined encoding scheme for a certain type of device and/or a service due to change of the contents of video content, for example.

The present invention has been made in view of these circumstances and an object thereof is to enable joint use of multiple schemes that are different in relationship of dependency between viewpoint images and depth images in encoding and decoding for encoding or decoding of viewpoint images and depth images.

### Means for Solving the Problems

(1) To attain the object, an image encoding device according to an aspect of the invention includes: a viewpoint image encoding portion that encodes a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images; a depth image encoding portion that encodes depth images by encoding depth images included in the encoding scheme change data unit with reference to viewpoint images if reference is to be made to viewpoint images, and encoding the depth images included in the encoding scheme change data unit without making reference to viewpoint images if reference is not to be made to viewpoint images; and an inter-image reference information processing portion that inserts inter-image reference information indicating reference relationships between the viewpoint images and the depth images in encoding for each the encoding scheme change data unit into an encoded data sequence that contains encoded viewpoint images and encoded depth images.

(2) In the image encoding device according to the invention, in response to the encoding scheme change data unit being a sequence, the inter-image reference information processing portion inserts the inter-image reference information into a header of a sequence in the encoded data sequence.

(3) In the image encoding device according to the invention, in response to the encoding scheme change data unit being a picture, the inter-image reference information processing portion inserts the inter-image reference information into a header of a picture in the encoded data sequence.

(4) In the image encoding device according to the invention, in response to the encoding scheme change data unit being a slice, the inter-image reference information processing portion inserts the inter-image reference information into a header of a slice in the encoded data sequence.

(5) In the image encoding device according to the invention, in response to the encoding scheme change data unit being a unit of encoding, the inter-image reference information processing portion inserts the inter-image reference information into a header of the unit of encoding in the encoded data sequence.

(6) An image decoding device according to another aspect of the invention includes: a code extraction portion that extracts from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit; a viewpoint image decoding portion that decodes the encoded viewpoint images extracted; a depth image decoding portion that decodes the encoded depth images extracted; and a decoding control portion that determines an order in which the encoded viewpoint images and the encoded depth images are decoded based on the reference relationships indicated by the inter-image reference information extracted.

(7) In the image decoding device according to the invention, in a case where the inter-image reference information indicates a reference relationship that an image which is one of an encoded viewpoint image and an encoded depth image has been encoded with reference to another, the decoding control portion performs control such that decoding of the other image is started after completion of decoding of the image, and in a case where the inter-image reference information indicates a reference relationship that an image which is one of an encoded viewpoint image and an encoded depth image has been encoded without making reference to another, the decoding control portion performs control such that decoding of the other image is started even before decoding of the image is completed.

(8) In the image decoding device according to the invention, the decoding control portion determines an order in which the encoded viewpoint images and the encoded depth images are decoded within a sequence serving as the encoding scheme change data unit based on the inter-image reference information extracted from a header of a sequence in the encoded data sequence.

(9) In the image decoding device according to the invention, the decoding control portion determines an order in which the encoded viewpoint images and the encoded depth images are decoded within a picture serving as the encoding scheme change data unit based on the inter-image reference information extracted from a header of a picture in the encoded data sequence.

(10) In the image decoding device according to the invention, the decoding control portion determines an order in which the encoded viewpoint images and the encoded depth images are decoded within a slice serving as the encoding scheme change data unit based on the inter-image reference information extracted from a header of a slice in the encoded data sequence.

(11) In the image decoding device according to the invention, the decoding control portion determines an order in which the encoded viewpoint images and the encoded depth images are decoded within an encoding unit serving as the encoding scheme change data unit based on the inter-image reference information extracted from a header of an encoding unit in the encoded data sequence.

(12) An image encoding method according to another aspect of the invention includes: a viewpoint image encoding step of encoding a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images; a depth image encoding step of encoding depth images by encoding depth images included in the encoding scheme change data unit with reference to the viewpoint images if reference is to be made to viewpoint images, and encoding the depth images included in the encoding scheme change data unit without making reference to viewpoint images if reference is not to be made to viewpoint images; and an inter-image reference information processing step of inserting inter-image reference information indicating reference relationships between the viewpoint images and the depth images in encoding for each the encoding scheme change data unit into an encoded data sequence that contains the encoded viewpoint images and the encoded depth images.

(13) An image decoding method according to another aspect of the invention includes: a code extraction step of extracting from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit; a viewpoint image decoding step of decoding the encoded viewpoint images extracted; a depth image decoding step of decoding the encoded depth images extracted; and a decoding control step of determining an order in which the encoded viewpoint images and the encoded depth images are decoded based on the reference relationships indicated by the inter-image reference information extracted.

(14) A program according to another aspect of the invention causes a computer to execute: a viewpoint image encoding step of encoding a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images; a depth image encoding step of encoding depth images by encoding depth images included in the encoding scheme change data unit with reference to the viewpoint images if reference is to be made to viewpoint images, and encoding the depth images included in the encoding scheme change data unit without making reference to viewpoint images if reference is not to be made to viewpoint images; and an inter-image reference information processing step of inserting inter-image reference information indicating reference relationships between the viewpoint images and the depth images in encoding for each the encoding scheme change data unit into an encoded data sequence that contains the encoded viewpoint images and the encoded depth images.

(15) A program according to another aspect of the invention causes a computer to execute: a code extraction step of extracting from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit; a viewpoint image decoding step of decoding the encoded viewpoint images extracted; a depth image decoding step of decoding the encoded depth images extracted; and a decoding control step of determining an order in which the encoded viewpoint images and the encoded depth images are decoded based on the reference relationships indicated by the inter-image reference information extracted.

### Effects of the Invention

As described above, the present invention enables joint use of multiple schemes that are different in relationship of dependency between viewpoint images and depth images in encoding and decoding for encoding or decoding of viewpoint images and depth images. It further provides the effect of the order in which viewpoint images and depth images are decoded being appropriately determined depending on their dependency relationships.

### BRIEF DESCRIPTION OF THE DRAWINGS

FIG. 1 shows an exemplary configuration of an image encoding device in an embodiment of the invention.

FIG. 2 shows an example of reference relationships among images for a first encoding scheme in the embodiment.

FIG. 3 shows an example of reference relationships among encoding target images in the embodiment.

FIG. 4 illustrates an exemplary picture structure in encoding target data in the embodiment.

FIG. 5 shows an exemplary structure of an encoded data sequence in the embodiment.

FIG. 6 shows examples of the insertion position of inter-image reference information for various kinds of encoding scheme change data unit in the embodiment.

FIG. 7 shows an example of a processing procedure carried out by the image encoding device in the embodiment.

FIG. 8 shows an exemplary configuration of an image decoding device in the embodiment.

FIG. 9 shows exemplary structures of a viewpoint image mapping table and a depth image mapping table in the embodiment.

FIG. 10 shows an example of a processing procedure carried out by the image decoding device in the embodiment.

### BEST MODE FOR CARRYING OUT THE INVENTION

[Image Encoding Device Configuration]

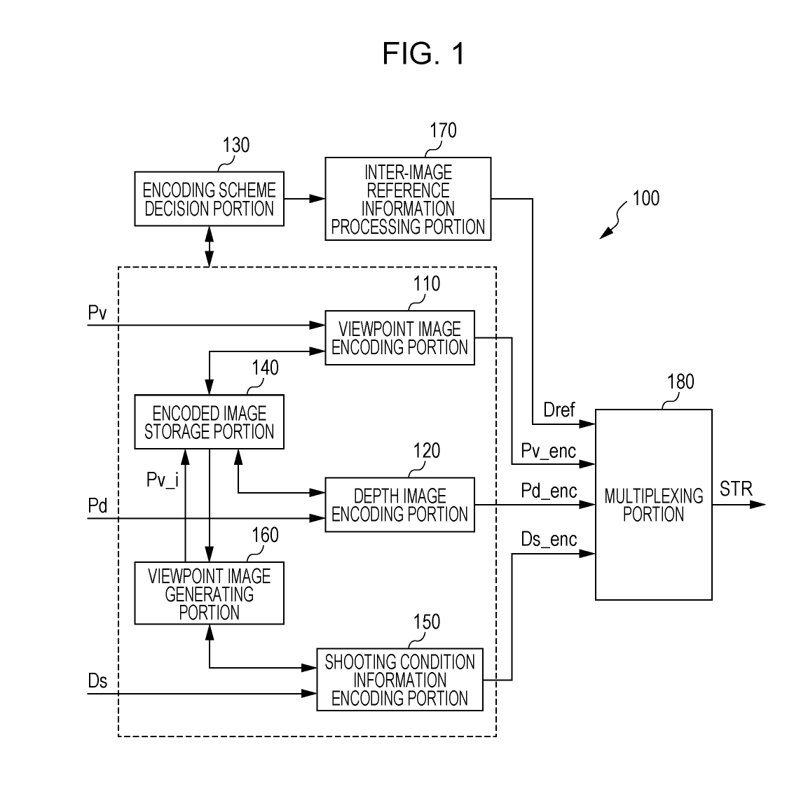

FIG. 1 shows an exemplary configuration of an image encoding device 100 in an embodiment of the invention.

The image encoding device 100 shown in this drawing includes a viewpoint image encoding portion 110, a depth image encoding portion 120, an encoding scheme decision portion 130, an encoded image storage portion 140, a shooting condition information encoding portion 150, a viewpoint image generating portion 160, an inter-image reference information processing portion 170, and a multiplexing portion 180.

The viewpoint image encoding portion 110 inputs multiple viewpoint images Pv respectively corresponding to different viewpoints and encodes the viewpoint images Pv.

The viewpoint images Pv corresponding to the viewpoints are images of subjects that are located at different positions (viewpoints) and present in the same field of view (object plane), for example. That is, a viewpoint image Pv is an image in which a subject is viewed from a certain viewpoint. An image signal representing the viewpoint image Pv is an image signal that has a signal value (intensity value) representing the color or density of subjects or the background contained in the object plane for each one of pixels arranged on a two-dimensional plane and also has a signal value representing the color space for each pixel. An example of an image signal having such signal values representing a color space is an RGB signal. An RGB signal contains an R signal representing the intensity value of the red component, a G signal representing the intensity value of the green component, and a B signal representing the intensity value of the blue component.

The depth image encoding portion 120 encodes a depth image Pd.

A depth image (also called “depth map” or “distance image”) Pd is an image signal representing a signal value (also called “depth value” or “depth”) indicating the distance from the viewpoint to a target object such as a subject or the background contained in the object plane as a signal value (pixel value) corresponding to each one of pixels arranged on a two-dimensional plane. The pixels forming the depth image Pd correspond to the pixels forming a viewpoint image. A depth image is information for representing the object plane in three dimensions using a viewpoint image that represents the object plane as projected onto a two-dimensional plane.

The viewpoint image Pv and the depth image Pd may correspond to either a moving image or a still image. Depth images Pd need not necessarily be prepared on a one-to-one basis for viewpoint images Pv corresponding to all the viewpoints. By way of example, when there are three viewpoint images Pv for three viewpoints, depth images Pd corresponding to two of the three viewpoint images Pv may be prepared.

Thus, the image encoding device 100 can perform multi-view image encoding due to inclusion of the viewpoint image encoding portion 110 and the depth image encoding portion 120. The image encoding device 100 supports three encoding schemes, described below as the first to third encoding schemes, for multi-view image encoding.

The first encoding scheme separately encodes the viewpoint image Pv and the depth image Pd by employing predictive coding in time direction and predictive coding in viewpoint direction in combination, for example. In the first encoding scheme, encoding and decoding of the viewpoint image Pv and encoding and decoding of the depth image Pd are independently performed without making reference to each other. That is, in the first encoding scheme, there is no dependency between the encoding and decoding of the viewpoint image Pv and the encoding and decoding of depth image Pd in either direction.

The first encoding scheme corresponds to the encoding method disclosed by PTL 1, for example.

The second encoding scheme generates a disparity-compensated image for a viewpoint other than the reference viewpoint based on the positional relationship between the depth image Pd and a viewpoint (the position of the image capture device for example) and encodes the viewpoint image Pv using the generated disparity-compensated image. In the second encoding scheme, reference is made to the depth image Pd for encoding and decoding of the viewpoint image Pv. That is, encoding and decoding of the viewpoint image Pv is dependent on the depth image Pd in the second encoding scheme.

The second encoding scheme corresponds to the encoding method disclosed by PTL 2, for example.

The third encoding scheme utilizes information such as motion vectors obtained in predictive coding of the viewpoint image Pv for encoding the depth image Pd. In the third encoding scheme, reference is made to the viewpoint image Pv in visualization and decoding of the depth image Pd. That is, in the third encoding scheme, encoding and decoding of the depth image Pd is dependent on the viewpoint image Pv.

The third encoding scheme corresponds to the encoding method of NPL 1, for example.

The first to third encoding schemes have their own advantages.

For example, since encoding data for the viewpoint image and that for the depth image are not dependent on each other, the first encoding scheme can reduce processing delay both in encoding and decoding. Additionally, influence of any partial degradation of the quality of depth images or viewpoint images does not propagate between the viewpoint images and the depth images because they are independently encoded.

The second encoding scheme incurs a relatively large processing delay because encoding and decoding of viewpoint images are dependent on the results of encoding and decoding of depth images. In this encoding method, however, a depth image of high quality results in a disparity-compensated image being generated with high accuracy, and the efficiency of compression by predictive coding using such a disparity-compensated image significantly improves.

The third encoding scheme uses information such as motion vectors of encoded viewpoint images for encoding of depth images and uses information such as motion vectors of decoded viewpoint images for decoding of depth images. This enables omission of some steps of processing such as motion search on depth images, leading to reduction in workload in encoding/decoding, for example.

Thus, the image encoding device 100 is able to conduct multi-view image encoding while changing the encoding scheme among the first to third encoding schemes at intervals of a predetermined encoding scheme change unit.

By switching among the different encoding schemes so as to use them advantageously for the contents of the video content being encoded, for example, both improvement of video content quality and enhancement of encoding efficiency can be achieved.

The encoding scheme decision portion 130 decides which one of the first to the third encoding schemes to use for multi-view image encoding, for example. For this decision, the encoding scheme decision portion 130 makes reference to the contents of externally input encoding parameters, for example. Encoding parameters are information that specifies various parameters for performing multi-view image encoding, for example.

When the encoding scheme decision portion 130 decides to use the first encoding scheme, the viewpoint image encoding portion 110 should not make reference to the depth image Pd in encoding the viewpoint image Pv. In this case, the viewpoint image encoding portion 110 encodes the viewpoint image Pv without making reference to the depth image Pd. Similarly, the depth image encoding portion 120 should not reference the viewpoint image Pv in encoding the depth image Pd. The depth image encoding portion 120 accordingly encodes the depth image Pd without making reference to the viewpoint image Pv.

When the encoding scheme decision portion 130 decides to use the second encoding scheme, the viewpoint image encoding portion 110 should reference the depth image Pd in encoding the viewpoint image Pv. The viewpoint image encoding portion 110 thus encodes the viewpoint image Pv with reference to the depth image Pd. The depth image encoding portion 120, in contrast, should not reference the viewpoint image Pv in encoding the depth image Pd. The depth image encoding portion 120 thus encodes the depth image Pd without making reference to the viewpoint image Pv.

When the encoding scheme decision portion 130 decides to use the third encoding scheme, the viewpoint image encoding portion 110 should not reference the depth image Pd in encoding the viewpoint image Pv. The viewpoint image encoding portion 110 thus encodes the viewpoint image Pv without making reference to the depth image Pd. In contrast, the depth image encoding portion 120 should reference the viewpoint image Pv in encoding the depth image Pd. The depth image encoding portion 120 thus encodes the depth image Pd with reference to the viewpoint image Pv.

The encoded image storage portion 140 stores decoded viewpoint images generated in the course of encoding of viewpoint images Pv by the viewpoint image encoding portion 110. The encoded image storage portion 140 also stores decoded depth images generated in the course of encoding of depth images Pd by the depth image encoding portion 120.

In the configuration of FIG. 1, the viewpoint image encoding portion 110 uses decoded depth images stored in the encoded image storage portion 140 as a reference image when making reference to the depth image Pd. The depth image encoding portion 120 uses decoded viewpoint images stored in the encoded image storage portion 140 as a reference image when making reference to the viewpoint image Pv.

The shooting condition information encoding portion 150 encodes shooting condition information Ds to generate encoded shooting condition information Ds_enc.

When the viewpoint image Pv is based on video signals captured by image capture devices, shooting condition information Ds includes information on placement position relationship such as the image capture device position for each viewpoint or the interval between image capture devices, for example, as information indicating the shooting conditions for the image capture devices. For viewpoint images Pv generated by computer graphics (CG) for example, the shooting condition information Ds includes information indicating the shooting conditions for virtual image capture devices that are assumed to have captured the images.

The viewpoint image generating portion 160 generates a viewpoint image Pv_i based on decoded viewpoint images and decoded depth images stored in the encoded image storage portion 140 and the shooting condition information. The encoded image storage portion 140 stores the viewpoint image Pv_i generated. The viewpoint image Pv_i thus generated is a viewpoint image to which viewpoint synthesis predictive coding is applied. It is thereby possible to generate an encoded viewpoint image that would be seen from a certain viewpoint other than the viewpoint of the viewpoint image Pv input by the viewpoint image encoding portion 110, for example.

The inter-image reference information processing portion 170 inserts inter-image reference information into an encoded data sequence STR.

That is, the inter-image reference information processing portion 170 generates inter-image reference information which indicates the reference relationships between viewpoint images and depth images in encoding for each encoding scheme change data unit. The inter-image reference information processing portion 170 then outputs the inter-image reference information it generated to the multiplexing portion 180 specifying the position of insertion.

The “reference relationships” indicated by the inter-image reference information specifically means relationship as to whether depth images Pd were referenced or not when the encoded viewpoint image Pv_enc was encoded or whether viewpoint images Pv were referenced or not when the encoded depth image Pd_enc was encoded.

The inter-image reference information processing portion 170 can recognize this reference relationship based on the result of encoding processing by the viewpoint image encoding portion 110 and the result of encoding by the depth image encoding portion 120. The inter-image reference information processing portion 170 can also recognize it based on the result of decision by the encoding scheme decision portion 130.

The multiplexing portion 180 inputs the encoding viewpoint image Pv_enc generated by the viewpoint image encoding portion 110, the encoded depth image Pd_enc generated by the depth image encoding portion 120, and the encoded shooting condition information Ds_enc at a certain timing and multiplexes them by time division multiplexing. The multiplexing portion 180 outputs the multiplexed data as an encoded data sequence STR in the form of a bit stream.

In doing so, the multiplexing portion 180 inserts inter-image reference information Dref at the specified insertion position in the encoded data sequence STR. The insertion position specified by the inter-image reference information processing portion 170 varies depending on the data unit used as the encoding scheme change data unit, which will be discussed later.

[Reference Relationship Among Images in Various Encoding Schemes]

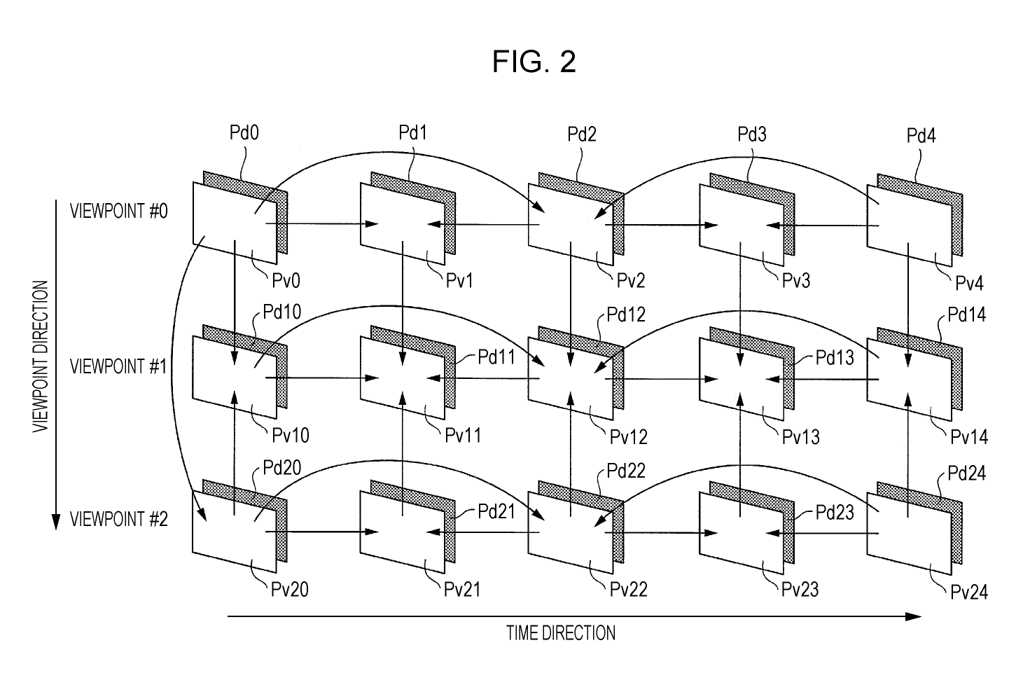

FIG. 2 shows an example of reference (dependency) relationships among images in the first encoding scheme. Note that this drawing illustrates a case where depth images Pd are generated for all the viewpoints.

This drawing depicts 15 viewpoint images Pv0 to Pv4, Pv10 to Pv14, Pv20 to Pv24, and depth images Pd0 to Pd4, Pd10 to Pd14, Pd20 to Pd24 corresponding to the same viewpoints and times, in a two dimension space defined by three viewpoints, #0, #1, #2, and the time direction.

In this drawing, an image illustrated on the endpoint side of an arrow represents the target image to be encoded. An image illustrated on the starting side of the arrow represents a reference image to be referenced when encoding the target image.

As an example, viewpoint image Pv11 for viewpoint #1 is encoded with reference to four viewpoint images Pv, namely viewpoint image Pv10 and viewpoint image Pv12 for the same viewpoint #1 but at earlier and later times respectively, and viewpoint images Pv1 and Pv21 at the same time but for other viewpoints #0, #2.

Although this drawing shows only reference relationships among viewpoint images Pv for the sake of clarity, similar reference relationships can hold with depth images Pd.

In FIG. 2, viewpoint #0 is defined as the reference viewpoint. The reference viewpoint is a viewpoint that does not use an image for other viewpoint as a reference image when an image corresponding to that viewpoint is encoded or decoded. As shown in FIG. 2, none of viewpoint images Pv0 to Pv4 for the viewpoint #0 makes reference to viewpoint images Pv10 to Pv14 or Pv20 to Pv24 corresponding to the other viewpoints #1 and #2.

Note that reference is also made to other images for decoding in the same reference relationships as FIG. 2 when encoded versions of the viewpoint images Pv and depth images Pd shown in FIG. 2 are decoded.

As will be understood from the foregoing, in the first encoding scheme, reference is made between viewpoint images Pv as well as between depth images Pd in predictive coding. However, no reference is made between a viewpoint image Pv and a depth image Pd.

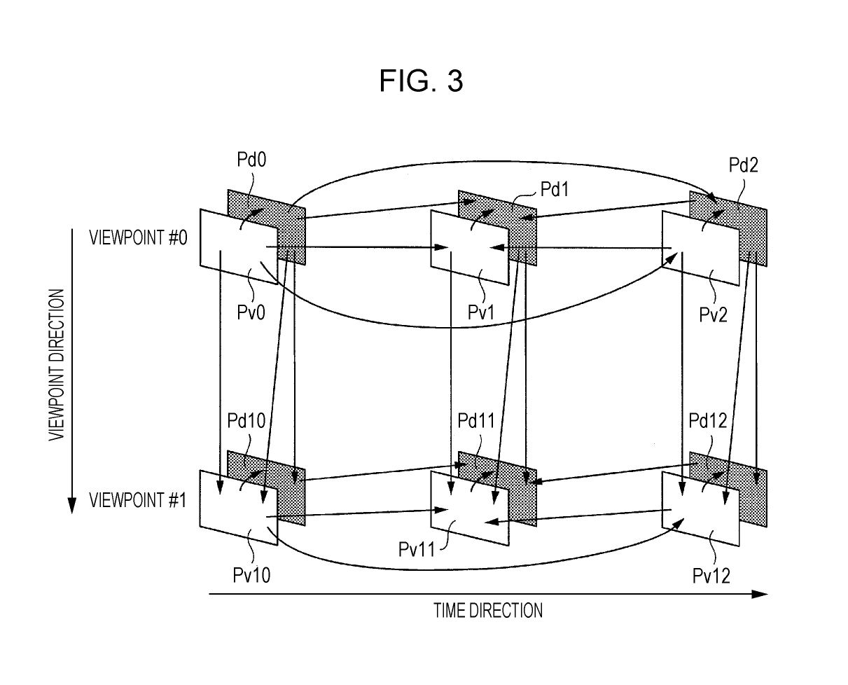

FIG. 3 shows an example of reference relationships among viewpoint images Pv and depth images Pd for a case where the first to third encoding schemes in this embodiment are used in combination. As noted above, the first to third encoding schemes cannot be used concurrently on the same encoding target data because they are different in the reference relationships between the viewpoint image Pv and the depth image Pd. In this embodiment, the encoding scheme being used is changed at intervals of a predetermined unit of encoding (encoding scheme change data unit), which may be a picture for example. FIG. 3 illustrates an example of changing the encoding scheme on a picture-by-picture basis.

In this drawing, six viewpoint images Pv0 to Pv2, Pv10 to Pv12, and corresponding six depth images Pd0 to Pd2, Pd10 to Pd12 are shown in a two dimension space defined by two viewpoints #0, #1, and the time direction.

Again, in this drawing, an image illustrated on the endpoint side of an arrow represents the target image to be encoded or decoded and an image illustrated on the starting side of the arrow represents a reference image to be referenced when encoding or decoding the target image.

As an example, depth image Pd11 for viewpoint #1 makes reference to depth images Pd10 and Pd12 for the same viewpoint #1 but at earlier and later time respectively, and depth image Pd1 for the other viewpoint #0 at the same time. The depth image Pd11 further makes reference to viewpoint image Pv11 corresponding to the same viewpoint and time.

The viewpoint image Pv11, referenced by depth image Pd11, makes reference to viewpoint images Pv10 and Pv12 for the same viewpoint #1 but at earlier and later times respectively, and viewpoint image Pv1 at the same time but for the other viewpoint #0. The viewpoint image Pv11 further makes reference to depth image Pd1 corresponding to the same viewpoint and time as the viewpoint image Pv1.

In accordance with the reference relationships shown in FIG. 3, viewpoint images Pv0 to Pv2, for example, are encoded by the first encoding scheme. Viewpoint images Pv 10 to Pv12 are encoded by the second encoding scheme. Depth images Pd0 to Pd2, Pd10 to Pd12 are encoded by the third encoding scheme.

For encoding with reference to other images as described above, the image to be referenced needs to be encoded once. Therefore, the order in which the viewpoint image Pv and the depth image Pd are encoded is determined by the reference relationship between the images.

To be specific, for the reference relationships in FIG. 3, the order of encoding will be: Pv0, Pd0, Pv10, Pd10, Pv2, Pd2, Pv12, Pd12, Pv1, Pd1, Pv11, Pd11, . . . .

[Exemplary Encoded Data Structure]

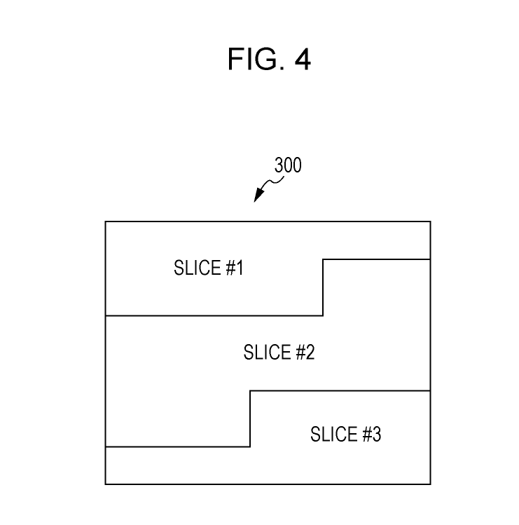

FIG. 4 illustrates a picture 300 corresponding to viewpoint image Pv as an example of data for encoding by the image encoding device 100 of this embodiment.

The picture 300 corresponding to viewpoint image Pv is image data corresponding to frames of video for example. The picture 300 is formed of a predetermined number of pixels, and the smallest unit of a pixel is signals of the color components making up the pixel (such as R, G, B signals, or Y, Cb, Cr signals).

The picture 300 is divided into blocks, which are sets of a predetermined number of pixels. The picture 300 in this embodiment is further partitioned by slice, which is a set of blocks. FIG. 4 schematically shows a picture 300 formed from three slices, #1, #2, and #3. A slice is the basic unit of encoding.

A picture corresponding to depth image Pd is also formed from a predetermined number of pixels as with the picture 300 corresponding to the viewpoint image Pv. The picture corresponding to depth image Pd is also divided into slices, which are sets of blocks. The depth image Pd differs from the viewpoint image Pv in that it only has information on the intensity value and has no color information.

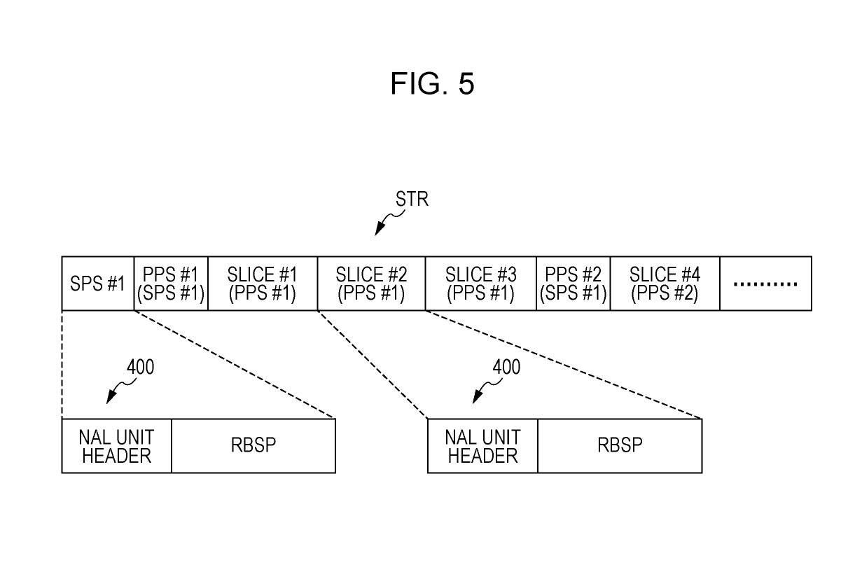

FIG. 5 schematically shows an exemplary structure of encoded data sequence STR in which an encoded picture 300 is multiplexed. The encoded data sequence STR conforms to image encoding standards H.264/Advanced Video Coding (AVC) or Multi-view Video Coding (MVC), for example.

In the encoded data sequence STR shown FIG. 5, a sequence parameter set (SPS) #1, a picture parameter set (PPS) #1, slice #1, slice #2, slice #3, PPS #2, slice #4, . . . are stored in order from the head to end of data.

SPS is information storing common parameters for the entire moving image sequence including multiple pictures, and includes the number of pixels forming a picture and pixel structure (the number of bits in a pixel) for example.

PPS is information storing per-picture parameters, including information indicating an encoding prediction scheme on a per-picture basis and/or the initial value of a quantization parameter for use in encoding, for example.

In the example in FIG. 5, SPS #1 stores parameters common for sequences that contain pictures corresponding to PPS #1 and PPS #2. PPS #1 and PPS #2 contain the SPS number “1” of SPS #1, which specifies which parameter set in the SPS #1 should be applied for each picture corresponding to PPS #1 and PPS #2.

PPS #1 stores parameters to be applied to slices #1, #2, #3, which form the corresponding picture. The slices #1, #2, #3 accordingly contain the number “1” of PPS #1, which specifies which parameter set in the PPS #1 should be applied to slices #1, #2, and #3.

Likewise, PPS #2 stores parameters for slice #4 and so on that form the corresponding picture. The slice #4 and so on accordingly contain the number “2” of PPS #2, which specifies which parameter set in the PPS #2 should be applied to slices #4 and so on.

Data included in the encoded data sequence STR such as SPS, PPS, and slices as in FIG. 5 are stored in a data structure of a network abstraction layer (NAL) unit (encoding unit) 400. The NAL unit thus is a unit for storing unit information such as SPS, PPS, and slices.

The NAL unit 400 is formed from a NAL unit header and a following raw byte sequence payload (RBSP) as also shown in FIG. 5.

Parameter sets and image encoding data stored in SPS, PPS, and slices are included in the RBSP. The NAL unit header contains identification information of the NAL unit. The identification information indicates the type of data stored in the RBSP.

[Exemplary Encoding Scheme Change Data Unit]

For encoding viewpoint images Pv and depth images Pd, the viewpoint image encoding portion 110 and depth image encoding portion 120 perform inter-frame predictive coding with reference to other images in time direction and viewpoint direction as described above in FIG. 3.

In encoding a viewpoint image Pv, the viewpoint image encoding portion 110 can perform predictive coding (viewpoint synthesis predictive coding) with a composite image generated utilizing depth image(s) Pd. That is, the viewpoint image encoding portion 110 can implement the second encoding scheme.

In encoding the depth image Pd, the depth image encoding portion 120 can perform encoding utilizing encoded information (such as motion vectors) of viewpoint images Pv. This can enhance the encoding efficiency compared to encoding performed only under the first encoding scheme shown in FIG. 1 (a scheme that performs encoding of viewpoint image Pv and depth image Pd separately only with prediction in time direction), for example.

Conversely, encoding only with the second or third encoding method may have the disadvantage of increase in processing delay, but using the first encoding scheme in combination can suppress increase of processing delay and maintain the image quality.

The viewpoint image encoding portion 110 and the depth image encoding portion 120 employ multiple encoding schemes in combination in encoding viewpoint images Pv and depth images Pd as described above by changing the encoding scheme being used at intervals of a predetermined encoding scheme change data unit as mentioned above. The inter-image reference information processing portion 170 inserts inter-image reference information into the encoded data sequence STR so that decoding can be performed with an encoding scheme appropriate for the encoding scheme change data unit.

An example of the encoding scheme change data unit and an example of the insertion position of inter-image reference information in the encoded data sequence STR corresponding to the encoding scheme change data unit in this embodiment are described next.

An example of the encoding scheme change data unit is a sequence. In this case, the encoding scheme decision portion 130 decides which one of the first to third encoding schemes to use on a per-sequence basis. The viewpoint image encoding portion 110 and the depth image encoding portion 120 then encode viewpoint images Pv and depth images Pd contained in a sequence in accordance with the encoding scheme determined

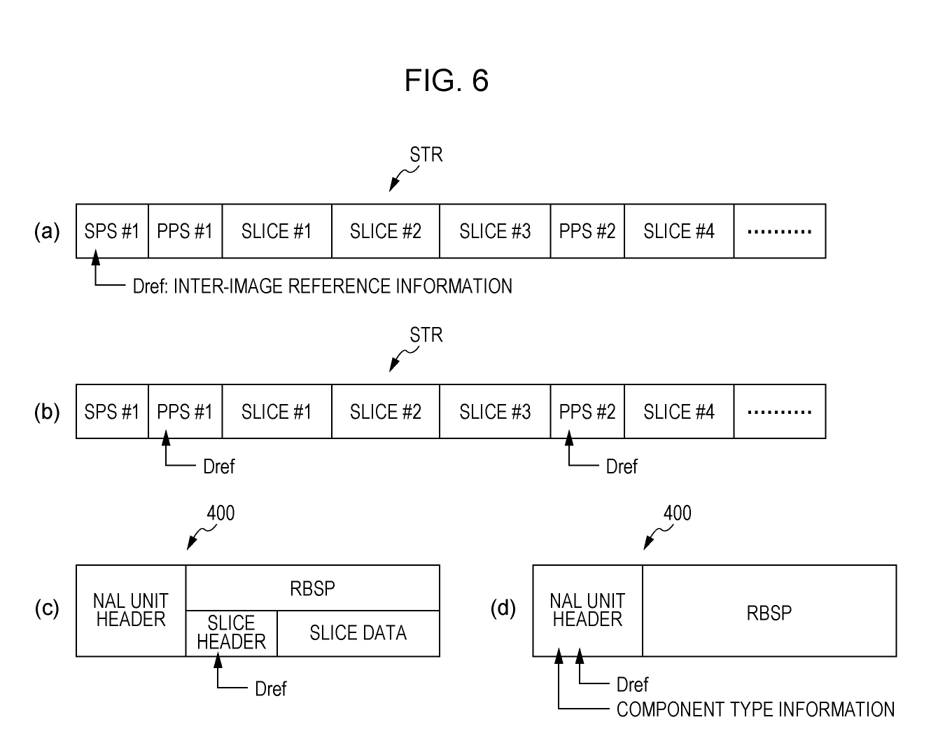

FIG. 6(a) shows an example of the insertion position of the inter-image reference information Dref for a case where a sequence is used as the encoding scheme change data unit. When the encoding scheme change data unit is a sequence, the inter-image reference information processing portion 170 inserts the inter-image reference information Dref at a predetermined position in the RBSP of SPS in the encoded data sequence STR, as shown in FIG. 6(a).

That is, the inter-image reference information Dref is output to the multiplexing portion 180 with the predetermined position specified as the insertion position. The multiplexing portion 180 performs multiplexing of the encoded data sequence STR so that the inter-image reference information Dref is inserted at the specified insertion position.

Another example of the encoding scheme change data unit is a picture. In this case, the encoding scheme decision portion 130 decides which one of the first to third encoding schemes to use on a per-picture basis. The viewpoint image encoding portion 110 and the depth image encoding portion 120 then encode viewpoint images Pv and depth images Pd contained in a picture respectively in accordance with the encoding scheme determined.

FIG. 6(b) shows an example of the insertion position of the inter-image reference information Dref for a case where a picture is used as the encoding scheme change data unit. When the encoding scheme change data unit is picture, the inter-image reference information processing portion 170 inserts the inter-image reference information Dref at a predetermined position in the RBSP of each PPS in the encoded data sequence STR as shown in FIG. 6(b).

Another example of the encoding scheme change data unit is slice. In this case, the encoding scheme decision portion 130 decides which one of the first to third encoding schemes to use on a per-slice basis. The viewpoint image encoding portion 110 and the depth image encoding portion 120 then encode viewpoint images Pv and depth images Pd contained in a slice respectively in accordance with the encoding scheme determined.

FIG. 6(c) shows an example of the insertion position of the inter-image reference information Dref for a case where a slice is used as the encoding scheme change data unit. When the encoding scheme change data unit is slice, the inter-image reference information processing portion 170 inserts the inter-image reference information Dref in the slice header located at the top of the RBSP in the NAL unit 400 as shown in FIG. 6(c).

FIG. 6(d) illustrates a case where the inter-image reference information Dref is stored in the NAL unit header of the NAL unit 400.

The NAL unit header is added to various types of data such as SPS, PPS, and slice as described in FIG. 5. Accordingly, when the inter-image reference information Dref is stored in the NAL unit header as in FIG. 6(d), the encoding scheme change data unit to which the inter-image reference information Dref corresponds is changed in accordance with the information stored in the NAL unit 400. This means that the type of the encoding scheme change data unit is changeable among sequence, picture, and slice, for example, in multi-view image encoding.

That is, when the inter-image reference information Dref is inserted in the NAL unit header of the NAL unit 400 which stores an SPS in the RBSP, the encoding scheme change data unit is sequence.

When the inter-image reference information Dref is inserted in the NAL unit header of the NAL unit 400 which stores a PPS in the RBSP, the encoding scheme change data unit is picture. A PPS can also specify multiple pictures as part of a picture, for example. Thus, when the encoding scheme (the reference relationships) may be changed in units of multiple slices, the degree of redundancy of encoded data can be reduced as compared to the case in FIG. 6(c).

When the inter-image reference information Dref is stored in the NAL unit header of the NAL unit 400 which inserts a slice into the RBSP, the encoding scheme change data unit is slice.

In the example of FIG. 6(d), it is necessary to distinguish between a viewpoint image and a depth image on a per-NAL-unit basis. To this end, component type information may be stored in the NAL unit header as information indicating the image type. Component refers to the type of the image to be encoded. Viewpoint image and depth image are each one type of component.

For the information indicating the image type, NAL unit identification information included in the NAL unit header by the standard may be employed instead of component type information. That is, the NAL unit identification information may identify an SPS for viewpoint images, a PPS for viewpoint images, a slice of viewpoint images, an SPS for depth images, a PPS for depth images, a slice of depth images, and the like.

The inter-image reference information Dref may be information indicating whether encoding of one of components representing the viewpoint image and the depth image made reference to the other component, for example. In this case, the inter-image reference information Dref can be defined as a one-bit flag (inter_component_flag) that indicates whether other images were referenced or not with “1” and “0”.

Specifically, for the first encoding scheme, the inter-image reference information Dref for the encoded viewpoint image Pv_enc stores “0”, indicating that no depth image Pd was referenced. Likewise, the inter-image reference information Dref for an encoded depth image Pd_enc stores “0”, indicating that no viewpoint image Pv was referenced.

In the second encoding scheme, the inter-image reference information Dref for an encoded viewpoint image Pv_enc stores “1”, indicating that depth image Pd was referenced. In contrast, the inter-image reference information Dref for an encoded depth image Pd_enc stores “0”, indicating that no viewpoint image Pv was referenced.

In the third encoding scheme, the inter-image reference information Dref for an encoded viewpoint image Pv_enc stores “0”, indicating that no depth image Pd was referenced. In contrast, the inter-image reference information Dref for an encoded depth image Pd_enc stores “1”, indicating that viewpoint images Pv were referenced.

Instead of the inter-image reference information Dref, information indicating which one of the first to third encoding schemes was used for encoding may be employed, for example.

[Exemplary Processing Procedure of the Image Encoding Device]

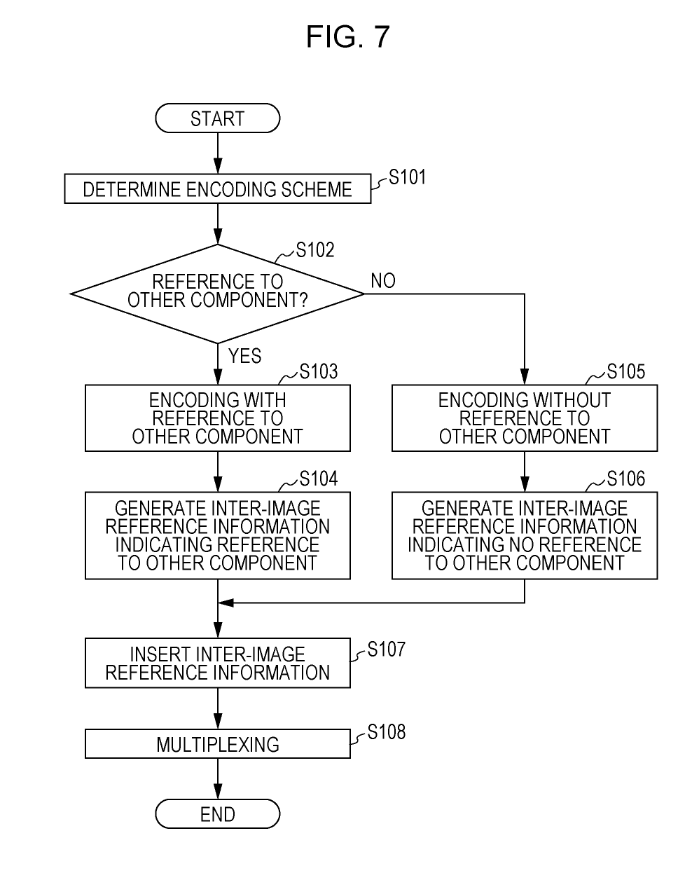

The flowchart in FIG. 7 illustrates an example of a processing procedure carried out by the image encoding device 100.

Encoding of viewpoint images Pv is described first. The encoding scheme decision portion 130 determines the encoding scheme used for viewpoint images Pv at intervals of a predetermined encoding scheme change data unit (step S101).

Next, the viewpoint image encoding portion 110 starts encoding of the viewpoint images Pv included in the encoding scheme change data unit with the encoding scheme determined At the start of encoding, the viewpoint image encoding portion 110 determines whether the encoding scheme determined involves reference to other components, namely depth images Pd or not (step S102).

If depth images Pd should be referenced (step S102: YES), the viewpoint image encoding portion 110 performs encoding with reference to depth images Pd as other components (step S103). As mentioned above, the viewpoint image encoding portion 110 retrieves the corresponding decoded depth images from the encoded image storage portion 140 and encodes the viewpoint images Pv utilizing the decoded depth images retrieved.

The inter-image reference information processing portion 170 then generates inter-image reference information Dref indicating that the components (the viewpoint images) encoded at step S103 have been encoded with reference to other components (depth images) (step S104). Specifically, the inter-image reference information processing portion 170 sets the one-bit inter-image reference information Dref to “1”.

If depth images Pd should not be referenced (step S102: NO), the viewpoint image encoding portion 110 performs encoding only with predictive coding between components of the same type (viewpoint images) without making reference to depth images Pd representing other components (step S105).

The inter-image reference information processing portion 170 then generates inter-image reference information Dref indicating that the components (viewpoint images) encoded at step S105 have been encoded without making reference to other components (depth images) (step S106). Specifically, the inter-image reference information processing portion 170 sets the one-bit inter-image reference information Dref to “0”.

The encoding scheme decision portion 130 also determines the encoding scheme for depth images Pd at step S101 in a similar manner. In response to the decision, the depth image encoding portion 120 carries out processing as per steps S102, S103, and S105 to encode the depth images Pd. The inter-image reference information processing portion 170 generates inter-image reference information Dref through processing similar to steps S104 and S106.

The inter-image reference information processing portion 170 then inserts the inter-image reference information Dref thus generated at a predetermined position in the encoded data sequence STR as illustrated in FIG. 6 in accordance with the predetermined encoding scheme change data unit (step S107). The inter-image reference information processing portion 170 then outputs the inter-image reference information Dref to the multiplexing portion 180 specifying the insertion position.

Although not shown in this drawing, encoding of shooting condition information is also performed by the shooting condition information encoding portion 150 in conjunction with the component encoding at steps S103 and S105. The multiplexing portion 180 then inputs the encoded components (encoded viewpoint images Pv_enc and encoded depth images Pd_enc), the encoded shooting condition information, and the header generated as per step S108. The multiplexing portion 180 performs time division multiplexing of the input data so that they are arranged in a certain order of arrangement and outputs them as an encoded data sequence STR (step S108).

[Image Decoding Device Configuration]

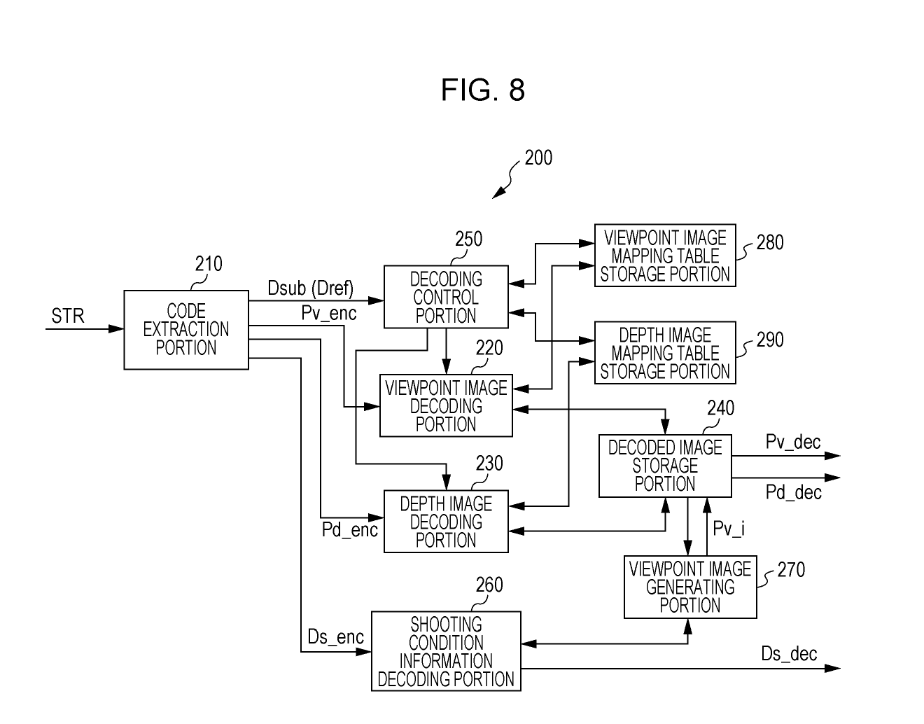

FIG. 8 shows an exemplary configuration of an image decoding device 200 in this embodiment. The image decoding device 200 shown in this drawing includes a code extraction portion 210, a viewpoint image decoding portion 220, a depth image decoding portion 230, a decoded image storage portion 240, a decoding control portion 250, a shooting condition information decoding portion 260, a viewpoint image generating portion 270, a viewpoint image mapping table storage portion 280, and a depth image mapping table storage portion 290.

The code extraction portion 210 extracts auxiliary information Dsub, encoded viewpoint images Pv_enc, encoded depth images Pd_enc, and encoded shooting condition information Ds_enc from an encoded data sequence STR inputted to it. The auxiliary information Dsub includes the inter-image reference information Dref described with FIG. 6.

The viewpoint image decoding portion 220 decodes an encoded viewpoint image Pv_enc separated from the encoded data sequence STR to generate a viewpoint image Pv_dec and outputs it to the decoded image storage portion 240. When a depth image needs to be referenced for decoding an encoded viewpoint image Pv_enc, the viewpoint image decoding portion 220 retrieves a depth image Pd_dec stored in the decoded image storage portion 240. Utilizing the retrieved depth image Pd_dec, it decodes the encoded viewpoint image Pv_enc.

The depth image decoding portion 230 decodes an encoded depth image Pd_enc separated from the encoded data sequence STR to generate a depth image Pd_dec and outputs it to the decoded image storage portion 240. When a viewpoint image needs to be referenced for decoding the encoded depth image Pd_enc, the depth image decoding portion 230 retrieves a viewpoint image Pv_dec stored in the decoded image storage portion 240. Utilizing the retrieved viewpoint image Pv_dec, it decodes the encoded depth image Pd_enc.

The decoded image storage portion 240 stores the viewpoint image Pv_dec decoded by the viewpoint image decoding portion 220 and the depth image Pd_dec generated by the depth image decoding portion 230. It also stores a viewpoint image Pv_i generated by the viewpoint image generating portion 270 discussed later. The viewpoint image Pv_i is used for decoding an encoded viewpoint image Pv_enc encoded by viewpoint synthesis predictive coding for example.

The viewpoint images Pv_dec stored in the decoded image storage portion 240 are utilized when the depth image decoding portion 230 performs decoding with reference to viewpoint images as mentioned above. Similarly, depth images Pd_dec stored by the decoded image storage portion are utilized when the viewpoint image decoding portion 220 performs decoding with reference to depth images.

The decoded image storage portion 240 outputs the viewpoint images Pv_dec and depth images Pd_dec stored therein to outside in an order of output following a specified order of display, for example.

The viewpoint images Pv_dec and depth images Pd_dec output from the image decoding device 200 as described above are reproduced by a reproduction device or an application (not shown), thereby displaying a multi-view image for example.

The decoding control portion 250 interprets the encoded data sequence STR based on the contents of the auxiliary information Dsub input to it and controls the decoding processing of the viewpoint image decoding portion 220 and the depth image decoding portion 230 in accordance with the result of the interpretation. As an example of control on decoding processing, the decoding control portion 250 performs control as described below based on the inter-image reference information Dref included in auxiliary information Dsub.

Assume that the inter-image reference information Dref indicates that components to be decoded (decoding target images) included in the encoding scheme change data unit were encoded with reference to other components (reference images). In this case, the decoding control portion 250 controls the viewpoint image decoding portion 220 or the depth image decoding portion 230 so as to decode the decoding target components with reference to other components.

Specifically, given that the inter-image reference information Dref indicates that the components to be decoded were encoded with reference to other components and the components to be decoded are viewpoint images and the other components are depth images, the decoding control portion 250 controls the viewpoint image decoding portion 220 so that encoded viewpoint images Pv_enc are decoded with reference to depth images Pd_dec.

Conversely, when the inter-image reference information Dref indicates that the components to be decoded were encoded with reference to other components and the components to be decoded are depth images and other components are viewpoint images, the decoding control portion 250 controls the depth image decoding portion 230 so that encoded depth images Pd_enc are decoded with reference to viewpoint images Pv_dec.

Assume now that the inter-image reference information Dref indicates that the components to be decoded included in the encoding scheme change data unit were encoded without making reference to other components.

In this case, the decoding control portion 250 performs control so that the components to be decoded are decoded without making reference to other components.

Specifically, when the components to be decoded are viewpoint images, the decoding control portion 250 then controls the viewpoint image decoding portion 220 so that encoded viewpoint images Pv_enc are decoded without making reference to depth images Pd_dec. Conversely, when the components to be decoded are depth images, the decoding control portion 250 controls the depth image decoding portion 230 so that encoded depth images Pd_enc are decoded without making reference to viewpoint images Pv_dec.

For decoding the components to be decoded with reference to other components as described above, the other components to which reference is made need to be already decoded. When decoding encoded viewpoint images Pv_enc and encoded depth images Pd_enc, the decoding control portion 250 therefore controls the order in which the encoded viewpoint images Pv_enc and encoded depth images Pd_enc are decoded so that the components to be referenced are decoded first.

For this control, the decoding control portion 250 uses a viewpoint image mapping table stored in the viewpoint image mapping table storage portion 280 and a depth image mapping table stored in the depth image mapping table storage portion 290. An example of decoding order control utilizing the viewpoint image mapping table and the depth image mapping table will be shown below.

The shooting condition information decoding portion 260 decodes the separated encoded shooting condition information Ds_enc to generate shooting condition information Ds_dec. The shooting condition information Ds_dec is output to outside and also output to the viewpoint image generating portion 270.

The viewpoint image generating portion 270 generates a viewpoint image Pv_i by using decoded viewpoint images and decoded depth images stored in the decoded image storage portion 240 and the shooting condition information Ds_dec. The decoded image storage portion 240 stores the viewpoint image Pv_i generated.

The viewpoint image mapping table storage portion 280 stores the viewpoint image mapping table.

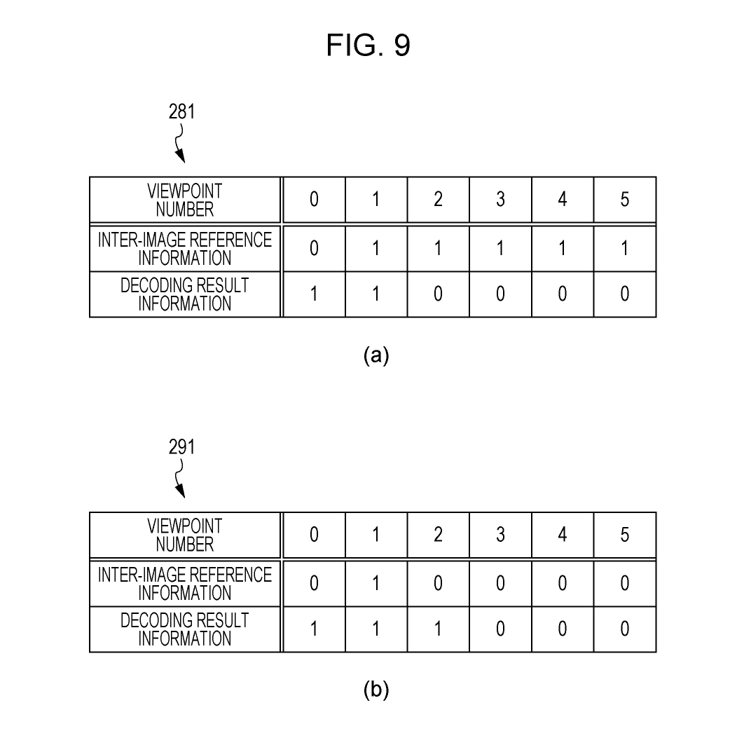

FIG. 9(a) illustrates an example of the structure of a viewpoint image mapping table 281. As shown in this drawing, the viewpoint image mapping table 281 maps an inter-image reference information value to decoding result information for each viewpoint number.

The viewpoint number is assigned in advance to each of the multiple viewpoints to which viewpoint images Pv correspond. For example, the viewpoints #0, #1, #2 shown in FIG. 2 are assigned viewpoint numbers 0, 1, 2, respectively.

The inter-image reference information value stores the contents of inter-image reference information Dref, that is, the value indicated by the inter-image reference information Dref for encoded viewpoint images Pv_enc corresponding to the same time for each viewpoint number. As mentioned above, inter-image reference information Dref being the value of “1” means that other components (depth images in this case) are referenced and inter-image reference information Dref being “0” means that other components are not referenced.

The decoding result information indicates whether decoding of the encoded viewpoint image Pv_enc for the corresponding viewpoint number is completed or not. The decoding result information may be one-bit information, for example, being “1” of which indicates that decoding is completed and “0” indicates that decoding is not completed.

The example of FIG. 9(a) shows viewpoint numbers “0” to “5”. This means that six different viewpoint are established here.

The inter-image reference information values in FIG. 9(a) indicate that encoded viewpoint images Pv_enc corresponding to the viewpoint number “0” were encoded without reference to depth images, while encoded viewpoint images Pv_enc for the other viewpoint numbers “1” to “5” were encoded with reference to depth images. This implies that the encoded viewpoint images Pv_enc for the viewpoint number “0” should not be decoded with reference to depth images, while encoded viewpoint images Pv_enc for viewpoint numbers “1” to “5” should be decoded with reference to depth images.

The decoding result information of FIG. 9(a) indicates that decoding of encoded viewpoint images Pv_enc for viewpoint numbers “0” and “1” is completed, while decoding of encoded viewpoint images Pv_enc for viewpoint numbers “2” to “5” is not completed yet at a certain point of time.

The depth image mapping table storage portion 290 stores the depth image mapping table.

FIG. 9(b) shows an exemplary structure of a depth image mapping table 291. As shown in this drawing, the depth image mapping table 291 maps an inter-image reference information value to decoding result information for each viewpoint number.

The viewpoint number is a number assigned in advance to each of the multiple viewpoints of viewpoint images Pv corresponding to depth images Pd.

The inter-image reference information value stores the value indicated by inter-image reference information for encoded depth images Pd_enc corresponding to the same time for each viewpoint number.

The decoding result information indicates whether decoding of encoded depth images Pd_enc for the corresponding viewpoint number is completed or not. The decoding result information may be one-bit information, for example, being “1” of which indicates that decoding is completed and “0” indicates that decoding is not completed.

FIG. 9(b) also shows viewpoint numbers “0” to “5”, illustrating a case where six different viewpoints are established.

The inter-image reference information values in FIG. 9(b) indicate that the encoded depth images Pd_enc for viewpoint numbers “0” and “2” to “5” were encoded without making reference to viewpoint images, while encoded depth images Pd_enc for viewpoint number “1” were encoded with reference to viewpoint images. This implies that the encoded depth images Pd_enc for viewpoint numbers “0” and “2” to “5” should not be decoded with reference to viewpoint images, while encoded depth images Pd_enc for viewpoint number “1” should be decoded with reference to viewpoint images.

The decoding result information in FIG. 9(b) indicates that decoding of depth images Pd_enc for viewpoint numbers “0” to “2” is completed, while decoding of depth images Pd_enc with for viewpoint numbers “3” to “5” is not completed at a certain point of time.

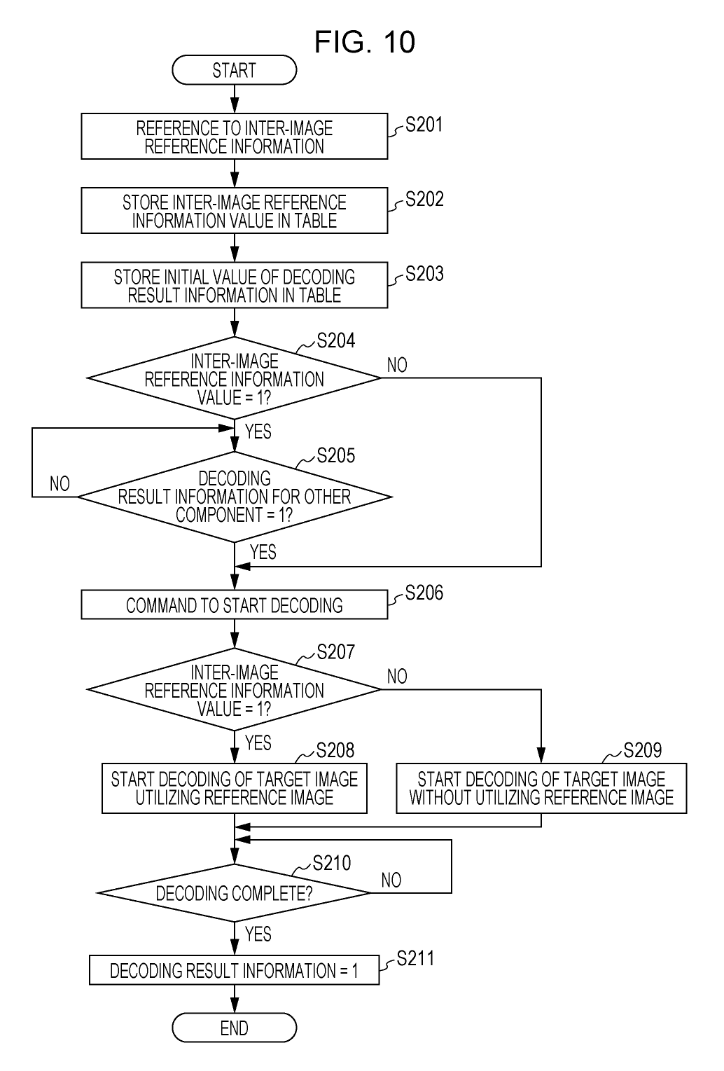

The flowchart of FIG. 10 illustrates an example of a processing procedure for the image decoding device 200 to decode encoded viewpoint images Pv_enc relevant to a certain viewpoint.

First, the decoding control portion 250 makes reference to the inter-image reference information Dref contained in the input auxiliary information Dsub (step S201), and stores the value of the referenced inter-image reference information Dref as the inter-image reference information value of the viewpoint number corresponding to the encoded viewpoint image Pv_enc to be decoded in the viewpoint image mapping table 281 (step S202).

The decoding control portion 250 also stores “0”, indicating that decoding is not completed, as the initial value of the decoding result information with the viewpoint number corresponding to the encoded viewpoint image Pv_enc to be decoded in the viewpoint image mapping table 281 (step S203).

The decoding control portion 250 then determines whether the inter-image reference information value stored in step S202 is “1” or not (step S204). This is equivalent to determining whether the encoded viewpoint image Pv_enc to be decoded was encoded with reference to a depth image or not, that is, whether the encoded viewpoint image Pv_enc to be decoded should be decoded with reference to a depth image or not.

When the inter-image reference information value is “1” (step S204: YES), the decoding control portion 250 waits for decoding result information for the same viewpoint number as the encoded viewpoint image Pv_enc to be decoded to become “1” in the depth image mapping table 291 (step S205: NO).

In other words, the decoding control portion 250 waits until the depth image Pd_dec to be referenced (the other component) is decoded when decoding the encoded viewpoint image Pv_enc to be decoded.

When the decoding result information has become “1” as a result of the depth image Pd_dec being decoded (step S205: YES), the decoding control portion 250 instructs the viewpoint image decoding portion 220 to start decoding (step S206).

If the inter-image reference information value is not “1” (step S204: NO), the decoding control portion 250 skips step S205 and instructs the viewpoint image decoding portion 220 to start decoding (step S206). In other words, the decoding control portion 250 instructs the viewpoint image decoding portion 220 to start decoding without waiting for decoding of the encoded depth image Pd_enc that corresponds to the same viewpoint number and time.

In response to the instruction to start decoding, the viewpoint image decoding portion 220 determines whether the inter-image reference information value for the viewpoint number of the encoded viewpoint image Pv_enc to be decoded is “1” or not in the viewpoint image mapping table 281 (step S207). In other words, the viewpoint image decoding portion 220 decides whether or not to decode the encoded viewpoint image Pv_enc to be decoded with reference to a depth image.

If the inter-image reference information value is “1” (step S207: YES), the viewpoint image decoding portion 220 starts decoding of the target encoded image utilizing the reference image (step S208).

Specifically, the viewpoint image decoding portion 220 retrieves the depth image Pd_dec corresponding to the same viewpoint number and time as the encoded viewpoint image Pv_enc to be decoded as the reference image from the decoded image storage portion 240. The viewpoint image decoding portion 220 then starts decoding of the encoded viewpoint image Pv_enc utilizing the retrieved depth image Pd_dec.

If the inter-image reference information value is “0” (step S207: NO), the viewpoint image decoding portion 220 starts decoding of the encoded viewpoint image Pv_enc (the decoding target image) without utilizing a depth image Pd_dec (a reference image) (step S209).

In this way, the viewpoint image decoding portion 220 makes reference to the inter-image reference information value stored by the decoding control portion 250 and decides whether or not to decode the encoded viewpoint image Pv_enc to be decoded with reference to a depth image. This means that decoding processing by the viewpoint image decoding portion 220 is under the control of the decoding control portion 250.

After starting decoding of the encoded viewpoint image Pv_enc as per step S208 or S209, the decoding control portion 250 waits for the decoding to be completed (step S210: NO). When the decoding is completed (step S210: YES), the viewpoint image decoding portion 220 stores “1”, indicating completion of decoding, as decoding result information corresponding to the viewpoint number of the encoded viewpoint image Pv_enc to be decoded in the viewpoint image mapping table 281 (step S211).

For decoding of an encoded depth image Pd_enc, a similar process to FIG. 10 is applied.

The decoding control portion 250 then makes reference to the inter-image reference information Dref corresponding to the encoded depth image Pd_enc to be decoded (step S201). The decoding control portion 250 stores the referenced value of the inter-image reference information Dref as the inter-image reference information value of the viewpoint number to which the encoded depth image Pd_enc to be decoded corresponds in the depth image mapping table 291 (step S202). The decoding control portion 250 also stores “0”, indicating that decoding is not complete, as the initial value of the decoding result information of the viewpoint number corresponding to the encoded depth image Pd_enc to be decoded in the depth image mapping table 291 (step S203).

If the inter-image reference information value is determined to be “1” (step S204: YES), the decoding control portion 250 waits for the decoding result information for the same viewpoint number as the encoded depth image Pd_enc to be decoded in the viewpoint image mapping table 281 to become “1” (step S205: NO).

Upon the decoding result information becoming “1” (step S205: YES), the decoding control portion 250 instructs the depth image decoding portion 230 to start decoding (step S206).

If the inter-image reference information value is not “1” (step S204: NO), the decoding control portion 250 skips step S205 and instructs the depth image decoding portion 230 to start decoding (step S206).

In response to the instruction to start decoding, the depth image decoding portion 230 determines whether the inter-image reference information value for the viewpoint number of the encoded depth image Pd_enc to be decoded is “1” or not in the depth image mapping table 291 (step S207).

If the inter-image reference information value is “1” (step S207: YES), the depth image decoding portion 230 starts decoding of the encoded depth image Pd_enc utilizing viewpoint images Pv_dec retrieved from the decoded image storage portion 240.

If the inter-image reference information value is “0” (step S207: NO), the depth image decoding portion 230 starts decoding of the encoded depth image Pd_enc (the decoding target image) without utilizing viewpoint images Pv_dec (reference images). (Step S209).

After starting decoding of the encoded depth image Pd_enc as per step S208 or S209, the decoding control portion 250 waits for the decoding to be completed (step S210: NO). When the decoding is completed (step S210: YES), the depth image decoding portion 230 stores “1”, indicating completion of decoding, as the decoding result information corresponding to the viewpoint number of the encoded depth image Pd_enc to be decoded in the depth image mapping table 291 (step S211).

As described in FIG. 3, the order of arrangement of encoded viewpoint images Pv_enc and encoded depth images Pd_enc in the encoded data sequence STR follows their reference relationships in encoding.

Thus, decoding of the referenced images has been started at the time when the inter-image reference information value in the viewpoint image mapping table 281 or the depth image mapping table 291 is referenced for determination at step S204 in FIG. 10, for example. Thus, by applying steps S204 and S205 in FIG. 10 in decoding of an encoded image that should be decoded with reference to other component images, it is ensured that decoding of the encoded image to be decoded is started after decoding of the referenced image is completed. This embodiment thereby can significantly reduce delay in image decoding processing that involves reference to other components.

Image encoding and decoding may be performed by recording programs to implement the functions of the components shown in FIGS. 1 and 8 in a computer-readable recording medium and having the programs on the recording medium read and executed by a computer system. The term “computer system” used herein is intended to include an OS and hardware such as peripherals.

A “computer system” should be also interpreted as including a website provision environment (or a display environment) when a WWW system is utilized.

The term “computer-readable recording medium” refers to storage devices including portable media such as flexible disks, magneto-optical disks, ROMs, and CD-ROMs, a hard disk contained in a computer system, and the like. The term “computer-readable recording medium” also includes media that maintain a program for a certain amount of time, such as volatile memory (RAM) in a computer system that serves as a server or a client in a case where a program is transmitted over a network such as the Internet or communication lines such as telephone lines. Such a program may implement part of the aforementioned functionality or implement the aforementioned functionality in combination with a program already recorded in a computer system.

While the embodiment of the invention has been described in detail with reference to drawings, its specific configuration is not limited to the embodiment but designs and the like within the scope of the invention are also encompassed.

### DESCRIPTION OF REFERENCE NUMERALS

100 image encoding device
110 viewpoint image encoding portion
120 depth image encoding portion
130 encoding scheme decision portion
140 encoded image storage portion
150 shooting condition information encoding portion
160 viewpoint image generating portion
170 inter-image reference information processing portion
180 multiplexing portion
200 image decoding device
210 code extraction portion
220 viewpoint image decoding portion
230 depth image decoding portion
240 decoded image storage portion
250 decoding control portion
260 shooting condition information decoding portion
270 viewpoint image generating portion
280 viewpoint image mapping table storage portion
281 viewpoint image mapping table
290 depth image mapping table storage portion
291 depth image mapping table

1. An image encoding device comprising:
a viewpoint image encoding portion that encodes a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images;
a depth image encoding portion that encodes depth images by encoding depth images included in the encoding scheme change data unit with reference to viewpoint images if reference is to be made to viewpoint images, and encoding the depth images included in the encoding scheme change data unit without making reference to viewpoint images if reference is not to be made to viewpoint images; and
an inter-image reference information processing portion that inserts inter-image reference information indicating reference relationships between the viewpoint images and the depth images in encoding for each the encoding scheme change data unit into an encoded data sequence that contains encoded viewpoint images and encoded depth images.

2. The image encoding device according to claim 1,
wherein in response to the encoding scheme change data unit being a sequence, the inter-image reference information processing portion inserts the inter-image reference information into a header of a sequence in the encoded data sequence.

3. The image encoding device according to claim 1,
wherein in response to the encoding scheme change data unit being a picture, the inter-image reference information processing portion inserts the inter-image reference information into a header of a picture in the encoded data sequence.

4. The image encoding device according to claim 1,
wherein in response to the encoding scheme change data unit being a slice, the inter-image reference information processing portion inserts the inter-image reference information into a header of a slice in the encoded data sequence.

5. The image encoding device according to claim 1,
wherein in response to the encoding scheme change data unit being a unit of encoding, the inter-image reference information processing portion inserts the inter-image reference information into a header of the unit of encoding in the encoded data sequence.

6. An image decoding device comprising:
a code extraction portion that extracts from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit;
a viewpoint image decoding portion that decodes the encoded viewpoint images extracted;
a depth image decoding portion that decodes the encoded depth images extracted; and
a decoding control portion that determines an order in which the encoded viewpoint images and the encoded depth images are decoded based on the reference relationships indicated by the inter-image reference information extracted.

7. The image decoding device according to claim 6,
wherein in a case where the inter-image reference information indicates that a decoding target image which is one of an encoded viewpoint image and an encoded depth image has been encoded with reference to another, the decoding control portion performs control such that decoding of the decoding target image is started after completion of decoding of the other image, and
wherein in a case where the inter-image reference information indicates that a decoding target image which is one of an encoded viewpoint image and an encoded depth image has been encoded without making reference to another, the decoding control portion performs control such that decoding of the decoding target image is started even before decoding of the other image is completed.

8. The image decoding device according to claim 6, wherein
the decoding control portion determines an order in which the encoded viewpoint images and the encoded depth images are decoded within a sequence serving as the encoding scheme change data unit based on the inter-image reference information extracted from a header of a sequence in the encoded data sequence.

9. The image decoding device according to claim 6, wherein
the decoding control portion determines an order in which the encoded viewpoint images and the encoded depth images are decoded within a picture serving as the encoding scheme change data unit based on the inter-image reference information extracted from a header of a picture in the encoded data sequence.

10. The image decoding device according to claim 6, wherein
the decoding control portion determines an order in which the encoded viewpoint images and the encoded depth images are decoded within a slice serving as the encoding scheme change data unit based on the inter-image reference information extracted from a header of a slice in the encoded data sequence.

11. The image decoding device according to claim 6, wherein
the decoding control portion determines an order in which the encoded viewpoint images and the encoded depth images are decoded within an encoding unit serving as the encoding scheme change data unit based on the inter-image reference information extracted from a header of an encoding unit in the encoded data sequence.

12. An image encoding method comprising:
a viewpoint image encoding step of encoding a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images;
a depth image encoding step of encoding depth images by encoding depth images included in the encoding scheme change data unit with reference to the viewpoint images if reference is to be made to viewpoint images, and encoding the depth images included in the encoding scheme change data unit without making reference to viewpoint images if reference is not to be made to viewpoint images; and
an inter-image reference information processing step of inserting inter-image reference information indicating reference relationships between the viewpoint images and the depth images in encoding for each the encoding scheme change data unit into an encoded data sequence that contains the encoded viewpoint images and the encoded depth images.

13. An image decoding method comprising:
a code extraction step of extracting from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit;
a viewpoint image decoding step of decoding the encoded viewpoint images extracted;
a depth image decoding step of decoding the encoded depth images extracted; and
a decoding control step of determining an order in which the encoded viewpoint images and the encoded depth images are decoded based on the reference relationships indicated by the inter-image reference information extracted.

14. A program for causing a computer to execute:
a viewpoint image encoding step of encoding a plurality of viewpoint images respectively corresponding to different viewpoints by encoding viewpoint images included in an encoding scheme change data unit with reference to depth images if reference is to be made to depth images indicating a distance from a viewpoint to a subject included in an object plane of the viewpoint images, and encoding the viewpoint images included in the encoding scheme change data unit without making reference to the depth images if reference is not to be made to depth images;
a depth image encoding step of encoding depth images by encoding depth images included in the encoding scheme change data unit with reference to the viewpoint images if reference is to be made to viewpoint images, and encoding the depth images included in the encoding scheme change data unit without making reference to viewpoint images if reference is not to be made to viewpoint images; and
an inter-image reference information processing step of inserting inter-image reference information indicating reference relationships between the viewpoint images and the depth images in encoding for each the encoding scheme change data unit into an encoded data sequence that contains the encoded viewpoint images and the encoded depth images.

15. A program for causing a computer to execute:
a code extraction step of extracting from an encoded data sequence encoded viewpoint images generated by encoding viewpoint images corresponding to different viewpoints, encoded depth images generated by encoding depth images indicating a distance from a viewpoint to a subject included in an object plane of the viewpoint images, and inter-image reference information indicating reference relationships between the viewpoint images and the depth images in encoding of the viewpoint images or the depth images for each predetermined encoding scheme change data unit;
a viewpoint image decoding step of decoding the encoded viewpoint images extracted;
a depth image decoding step of decoding the encoded depth images extracted; and
a decoding control step of determining an order in which the encoded viewpoint images and the encoded depth images are decoded based on the reference relationships indicated by the inter-image reference information extracted.
